(19) United States
(12) Patent Application Publication
(10) Pub. No.: US 2005/0097123 A1
(43) Pub. Date: May 5, 2005

(54) Research data repository system and method

(75) Inventor: Ock Kee Baek, Unionville (CA)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 10/970,517

(22) Filed: Oct. 21, 2004

(30) Foreign Application Priority Data
Oct. 31, 2003 (CA) 2447961

(51) Int. Cl. G06F 17/00

(52) U.S. Cl. 707/102

(57) ABSTRACT

System, method and program product for managing reference data. A data access program receives data retrieval policies and retrieve reference data from remote sources in accordance with the data retrieval policies. A research application assists in generating a conclusion based on said reference data which has been retrieved. A local data system stores the reference data retrieved by the data access program. The local data system associates the conclusion with the retrieved reference data. In response to retrieval of updates to the reference data, the local data system records that the conclusion is based on stale reference data, and can notify an entity responsible for the conclusion that the conclusion is based on stale reference data. Optionally, the local data system can notify the research application to process the updated reference data to assist in generating a new conclusion or validating the first conclusion, as the case may be, based on the updated reference data.

### BACKGROUND OF THE INVENTION

The present invention relates generally to a data repository for scientific information. More particularly, the present invention relates to a data repository system and method for automatically obtaining and maintaining scientific reference information for use by a team of researchers.

Modem scientific research, and particularly research in the life sciences areas, typically involves the use of a large amount of external reference data by a large, multidisciplinary, research team. In the case of life sciences research, such external reference data can include human Genome information, such as that maintained by the US National Institutes of Health, and protein information, such as that in the SWISS-PROT databank, etc. Access to timely, correct and complete external reference data can mean the difference between success or failure in the research project. Further, even when access to necessary reference data is available, delays in providing access to that data can result in research delays which, in turn, can result in significant economic expenses and/or losses.

Accordingly, many research teams spend significant time and effort in ensuring that they have timely access to necessary reference data. Unfortunately, accessing reference data in external databases can be cumbersome and inefficient, not only due to data transmission difficulties and delays through public networks, but also because the external data is seldom organized or formatted in an optimal manner for a given research team. Further, data models and/or schemas in such external reference databases tend to change over time requiring an ongoing effort by a research team to maintain access to up-to-date reference information.

FIG. 1 shows a prior art approach for providing members of a scientific research team 20 with access to external reference data. In FIG. 1, the research team 20 is provided with reference data from external databases 24 in one of two manners. Depending upon the data base, research team 20 may be provided with copies of the data via physical media, such as tapes, disk cartridges, etc. and this is indicated in FIG. 1 by the dashed lines from the databases 24 to the research team 20. The other manner in which research team 20 is provided with the research data from external databases 24 is via data networks 32, which can be private data networks or, more commonly, public data networks such as the Internet. In the approach of FIG. 1, a program 36 to provide federated access is preferably employed to access databases 24. Program 36 can be any suitable program which provides federated access to disparate data sources. A research application 40 allows research team 20 to make appropriate queries and receive the responses from databases 24, and then process the data to assist in making conclusions regarding the data.

An object of the present invention is to provide a system, method and program product which manages reference data and research conclusions based on the reference data.

Another object of the present invention is to synchronize remote and local data repositories in support of the research.

### SUMMARY OF THE INVENTION

The invention resides in a system, method and program product for managing reference data. A data access program receives data retrieval policies and retrieve reference data from remote sources in accordance with the data retrieval policies. A research application assists in generating a conclusion based on said reference data which has been retrieved. A local data system stores the reference data retrieved by the data access program. The local data system associates the conclusion with the retrieved reference data. In response to retrieval of updates to the reference data, the local data system records that the conclusion is based on stale reference data.

In accordance with features of the present invention, in response to the retrieval of updates to the reference data, the local data system notifies an entity responsible for the conclusion that the conclusion is based on stale reference data. Optionally, the local data system can notify the research application to process the updated reference data to assist in generating a new conclusion or validating the first conclusion, as the case may be, based on the updated reference data.

### BRIEF DESCRIPTION OF THE DRAWINGS

FIG. 1 is a block diagram illustrating a data repository system for providing reference data to a scientific research team, according to the Prior Art.

FIG. 2 is a block diagram illustrating a data repository system for providing reference data to a scientific research team, according to the present invention.

FIG. 3 is a flowchart of a data repository method used in the system of FIG. 2.

FIG. 4 is a flowchart of a function performed by a content management engine/program of the system of FIG. 2 to manage reference data and conclusions based on the reference data.

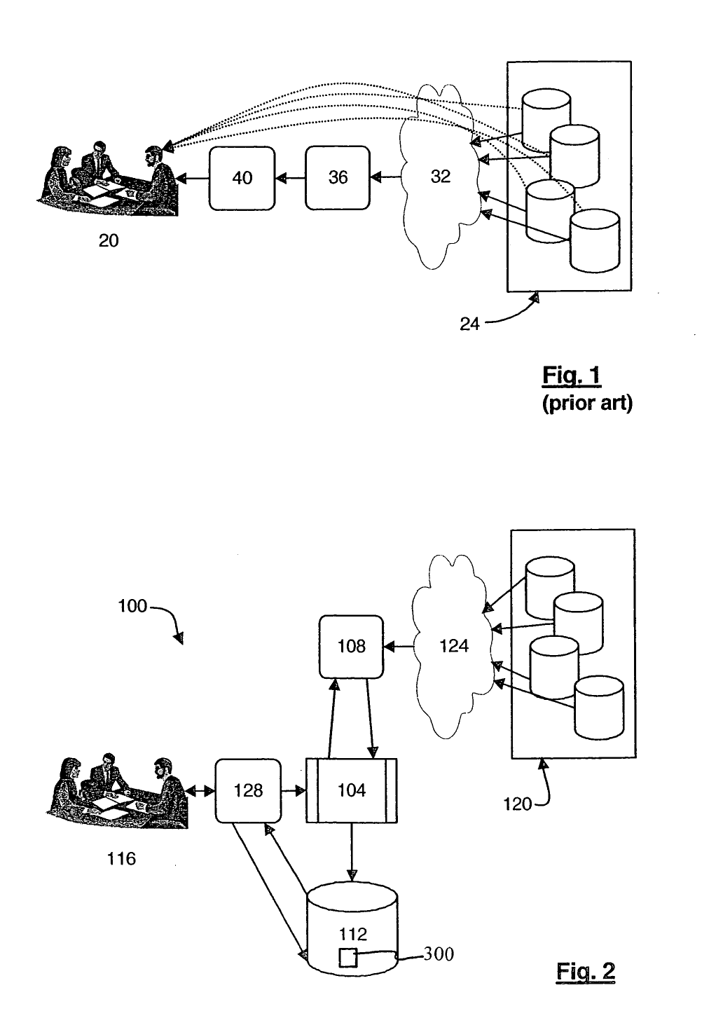

### DETAILED DESCRIPTION OF THE INVENTION

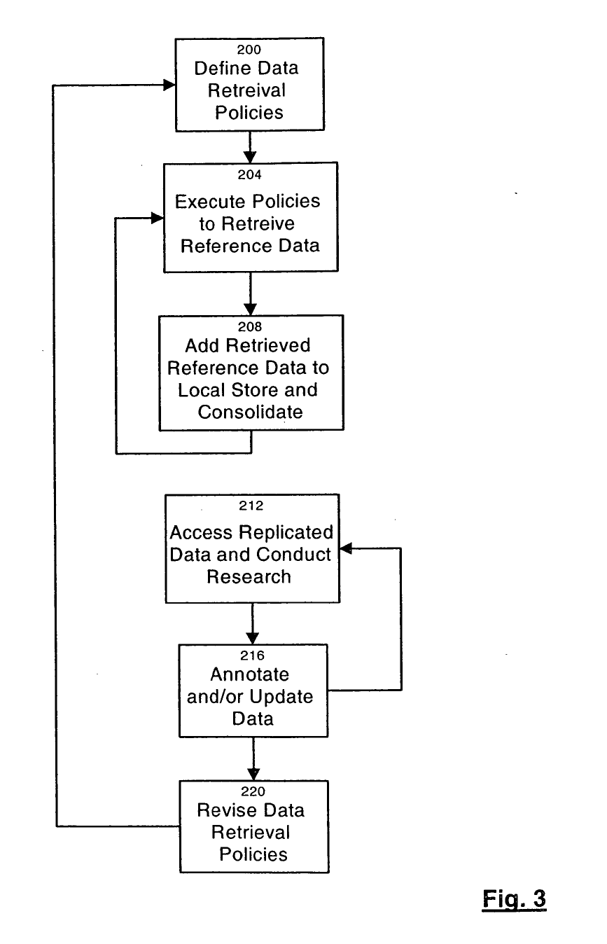

FIG. 2 illustrates a data repository system generally designated 100 in accordance with an embodiment of the present invention. The data repository system 100 in FIG. 2, includes a content management engine 104 which interfaces with a federated data access program 108 and a local data store 112. Federated data access program 108 can be any suitable program, such as the IBM DB2® Information Integrator program, which provides federated access to disparate data.

Content management engine 104 can comprise computer hardware and associated operating system, such as IBM pSeries Servers running IBM AIX® and/or Linux, which are operable to check and retrieve external reference information, operating in combination with a suitable program, such as the DB2 Content Manager®, marketed by IBM, or other programs providing an equivalent set of functions as described herein.

A research team 116 using system 100 defines external reference data retrieval policies for content management engine 104. These policies define (a) external data bases and other data sources of interest, (b) types of information of interest, (c) time intervals at which external reference information is to be checked for updates, (d) conditions for event notifications when there is any change on data sources of interest, and/or (e) additions and properties for such information, such as whether the external information is to be explicitly replicated within system 100, or the meta data is to be maintained within the system 100, the update priority of such information, etc. These external data reference retrieval policies are preferably defined in XML (Extensible Markup Language) by research team 116 and are stored in and executed by content management engine 104. Content management engine 104 executes the retrieval policies, through federated data access program 108, to retrieve desired information from external data bases 120 of interest. The retrieval can be performed through private or public data networks 124, such as the Internet, as illustrated and/or by periodic receipt and accessing of disk cartridges, tape libraries or other physical media provided to research team 116.

As content management engine 104 executes the external data reference retrieval policies, it interoperates with local data store 112 to update information already replicated in local data store 112, to replicate new information to local data store 112 and to remove, or appropriately label, out of date or questionable information in local data store 112. Local data store 112 can comprise, in combination, any suitable data management system, such as the DB2® database product marketed by IBM, and any suitable data storage device or system, such as an Enterprise Storage Server marketed by IBM.

As used herein, the term “local” does not refer to a geographic location, but instead to a logical location. Specifically, the term local refers to the data store being accessible by researchers without requiring that data sent between the researchers and the data store to traverse public networks. (This avoid delays in access, and the possibility of unauthorized access.) While it is contemplated that members of research team 116 will access local data store 112 through a private data network, any suitable access method, including a virtual private network or other encrypted link (e.g. SSL, TLS, PKI, etc.) carried over a public network, is considered to be “local” to the data store as this term is intended herein. Unlike the prior art approaches wherein members of a research team directly query external databases, via a federated data base or otherwise, in the present invention members of a research team 116 query and interact with local data store 112 via one or more conventional research applications 128. Thus, queries generated by research team 116 do not travel over data networks 124 but instead are applied to local data store 112. Further, data stored in local data store 112 can be stored as federated data, allowing faster queries to be made as the data stored in a federated state can be effectively optimized for the interests and uses of research team 116. Also, queries can be applied to local data store 112 typically much more quickly than similar queries can be transmitted over data networks 124.

Also, system 100 notifies the research team when existing reference data is updated (by someone in the research team, an automatic sensor or someone outside of the research team), where the existing reference data was the basis for prior analysis results or research outcomes, also referred to as “conclusions”. This keys the research team of the opportunity to check the (current) validity of the conclusion based on the updated research data. The checking can be performed by processing the updated reference data with one or more research applications.

Also, using one or more research applications 128, members of research team 116 can provide annotations, additions and/or corrections to the reference data and/or conclusions in local data store 112. When such annotations, corrections and/or additions have been made, content management engine 104 will preserve the original data and the added information within local data store 112 even after updates, corrections or changes have been retrieved from external data bases 120. This allows research team 116 to create and maintain its own local knowledge independent of the contents of external data bases 120.

If research team 116 requires access to data not in local data store 112, content management engine 104 will determine how best to obtain the information. Content management engine 104 can, via federated data access program 108, replicate appropriate portions of external databases 120 containing required information into local data store 1112. If such a replication cannot be performed in real time, content management engine 104 can cache a pending query until the replication has been performed and can advise members of research team 116 that a response to the query will be provided once the replication is complete.

Research team 116 can, from time to time, (a) update and/or modify the data retrieval policies implemented by content management engine 104 to obtain new classes of information, as the research effort moves in new directions, (b) employ new sources of external information as such information becomes available, and (c) cease retrieval of some external information as the research effort moves away from the need for such information.

A flowchart of a data repository method in accordance with an aspect of the present invention is illustrated in FIG. 3. As shown, at step 200 research team 116 defines a set of external reference data retrieval policies. These retrieval policies identify: (a) data of interest for retrieval, (b) the external sources from which the data is to be retrieved, (c) types of information of interest, (d) time intervals at which external reference information is to be checked for updates, and/or (d) additions and properties for such information, such as whether the external information is to be explicitly replicated within system 100, the update priority of such information, etc. The retrieval policies will be executed within the method to retrieve external reference data of interest to research team 116. These retrieval policies can be created in a variety of manners, but it is presently preferred that they be defined in XML as a variety of tools exist for creating and using XML.

At step 204, content management engine 104 and federated data access program 108 execute the defined retrieval policies to retrieve the reference data of interest. The retrieval of reference information can be performed in real time, or as a batch process, depending upon the importance of the reference data to research team 116, the time required to perform the retrieval and the amount of data. Data retrieval policies can indicate a preferred time of day for retrieval of reference information to improve this process. For example, overnight retrieval may be performed for particularly busy external databases 120.

At step 208, content management engine 104 stores replicas of the retrieved information or federated images of such information in local data store 112 and consolidates that storage. In particular, if previous copies of the replicated information already exist within local data store 112, content management engine 104 will either replace the previous information or add the new replicated information to the previous information, depending upon the defined data retrieval policy for the information, while preserving any annotations or corrections made by research team 116 in both cases. Further, this consolidation can comprise reorganizing the retrieved data, in combination with other retrieved data or by itself, in a schema or organization which is appropriate for the research efforts of research team 116.

Steps 204 and 208 are repeated, as necessary and at appropriate intervals as defined in the retrieval policies, to keep the data in local data store 112 current for research team 116.

At step 212, one or more researchers of research team 116 access reference information and/or annotations, etc. stored in local data store 112 in the course of conducting their research. This access can be via any appropriate research application 128. Queries from research application 128 are applied to the replicated information in local data store 112, and if necessary, to any federated information from external databases 120 which has not been replicated with local data store 112.

At step 216, members of research team 116 can annotate, correct and/or update replicated reference information in local data store 112. As mentioned above, any annotations, corrections or additions made by research team 116, are preserved in local data store 112, along with the replica of the original reference information to which they apply, even if changes to that reference information are subsequently replicated by content management engine 104. Steps 212 and 216 are repeated at intervals, by research team 116, as desired.

As shown at step 220, another outcome of steps 212 and 216 can be a revising of the data retrieval policies previously created by team 116 at step 200. As research team 116 pursues their research effort and/or reviews external reference data, research team 116 can identify new areas of reference information of interest and existing areas that are no longer of interest. Research team 116 can amend and/or augment the previously defined external data retrieval polices when desired and the foregoing method of FIG. 3 will recommence and implement the new retrieval policies.

Part of the amendment/augmentation of the retrieval policies can be a definition of whether data previously replicated to local data store 112 is to be maintained therein, or if the replica (and any annotations, etc.) is no longer of interest and can be safely removed from local data store 112. It is contemplated that, for regulatory and/or research audit purposes, in most cases research team 116 will maintain all replicated information in local data store 112, even if that replicated information is of no further use for the research efforts.

Data repository systems and methods in accordance with the present invention provide advantages over prior art approaches. External reference information of interest to a scientific research team is automatically and continuously retrieved and organized in a local data store in accordance with retrieval policies established by the research team. The research team can easily annotate, correct and/or update external reference information for its own use. Research queries of the external information do not traverse public networks, thus mitigating security concerns which would otherwise occur.

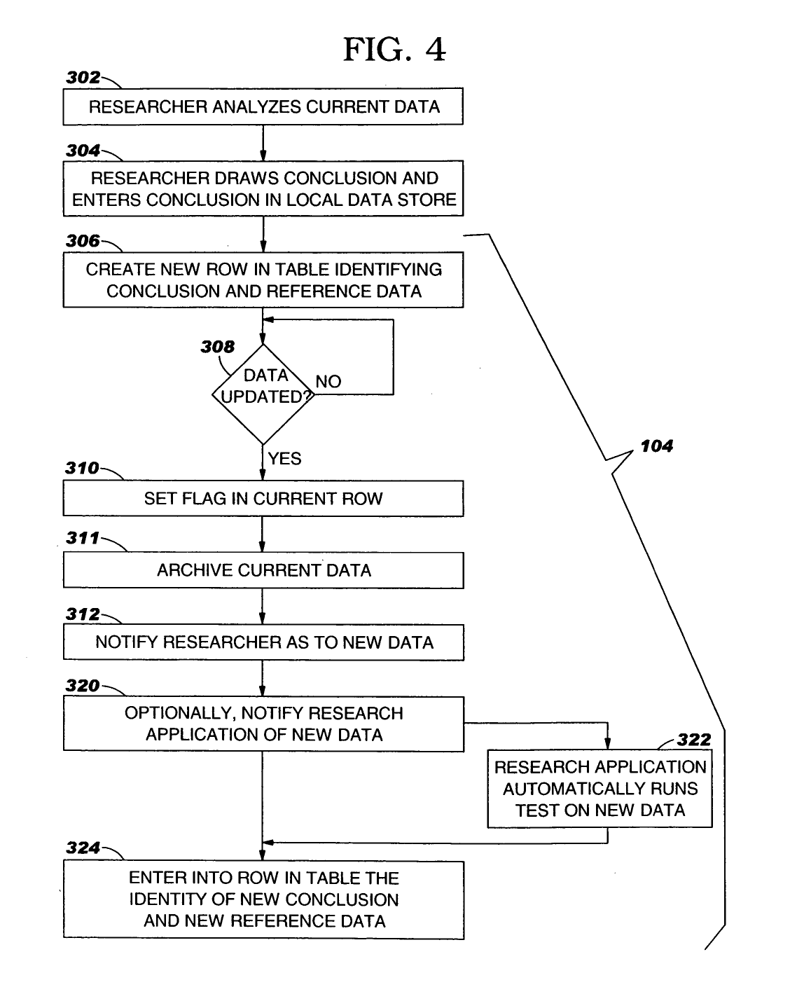

Also, in accordance with the present invention, system 100 is used as illustrated in FIG. 4 to correlate conclusions drawn by researchers to the data upon which the conclusion is based. For example, the conclusion can be the efficacy of a new drug, and the data can be the clinical test results of the drug. A researcher, using a research application(s) 128, analyzes existing data in the local data store 112 which has been retrieved from the remote, external databases 120 in accordance with the data retrieval policies (step 302). After the analysis is complete, the researcher draws a conclusion based on this existing data as processed by the research application(s), and enters the conclusion in the local data store 112 (step 304). The content management engine/program 104 then creates a table 300 with a row of entries which indicates for this conclusion a pointer to the existing data in the local data store 112 upon which the conclusion was drawn (step 306). The table 300 also includes the date that this existing data was last updated. If this data is subsequently updated in the external database 120 (by this researcher, another researcher, or automatically by a sensor) and retrieved to the local data store 112 in accordance with the data retrieval policies (decision 308, yes branch), the content management engine 104 will enter into this row of the table the latest date that this data was updated, and a flag to indicate that the existing conclusion is not based on the latest data (step 310). The content management engine 104 will also retain/archive the version of the data upon which the conclusion was based, i.e. before any updates to the data (step 311). Also, the content management engine 104 will notify the researcher that there is new data relating to a previous conclusion (step 312), so the researcher can decide whether to analyze the new data using the research application 128. Optionally, the content management engine 104 can notify the research application 128 (step 320) to automatically run the same tests and functions on the new data as were run on the old data (step 322), and output and store the new conclusion in another row of the table (step 324). This other row of the table would include for this new conclusion, a pointer to the new data upon which it is based, and the date of this new data. The following is an example of the table 300 showing both rows of entries.

| Conclusion | Name of Reference | | |
|---|---|---|---|
| directory/name | File Data | Last Update Date | Flag |
| TeamA/ThyroidCancer1 | TestData_ThyroidX | 01/01/2004 | Yes |
| TeamA/ThyroidCancer2 | TestData_ThyroidY | 06/15/2004 | No |

The above-described embodiments of the present invention are intended to be examples of the present invention and alterations and modifications may be effected thereto, by those of skill in the art, without departing from the scope of the invention which is defined solely by the claims appended hereto.

1. A system for managing reference data, said system comprising:
a data access program to receive data retrieval policies and retrieve reference data from remote sources in accordance with the data retrieval policies;
a research application to assist in generating a conclusion based on said reference data which has been retrieved; and
a local data system to store the reference data retrieved by the data access program, the local data system associating said conclusion with said retrieved reference data; and wherein, in response to retrieval of updates to said reference data, the local data system records that the conclusion is based on stale reference data.

2. The system of claim 1 wherein said data retrieval policies comprise an identification of said remote sources, an identification of a type of reference data required for said conclusion, and specification of time intervals at which said remote sources should be checked for updates.

3. The system of claim 2 where the data retrieval policies also include an indication of an update priority of the reference data.

4. The system of claim 1 wherein, in response to retrieval of updates to said reference data, the local data system notifies an entity responsible for said conclusion that said conclusion is based on stale reference data.

5. The system of claim 1 wherein, in response to retrieval of updates to said reference data, the local data system notifies said research application to process said updated reference data to assist in generating a new conclusion or validating the first said conclusion, as the case may be, based on said updated reference data.

6. A computer program product to manage reference data and conclusions based on the reference data, said computer program product comprising:
a computer readable medium;
first program instructions to retrieve reference data;
second program instructions to execute a research application on said reference data to assist in generating a conclusion based on said reference data; and
third program instructions to define a table identifying said conclusion and said reference data as the basis for said conclusion; and wherein
said first program instructions subsequently retrieve updated reference data;
said third program instructions update said table to indicate that said conclusion is based on reference data for which updates are available; and
said first, second and third program instructions are recorded on said medium.

7. A computer program product as set forth in claim 6 wherein said third program instructions also notify an entity responsible for said conclusion that there is new reference data related to said conclusion.

8. A computer program product as set forth in claim 6 wherein, in response to retrieval of said new reference data, said second program instructions executes said research application with said new reference data to assist in generating a new conclusion or validating the first said conclusion, as the case may be, based on said new reference data.

9. A computer program product as set forth in claim 6 further comprising:
fourth program instructions, responsive to a request to access said conclusion after retrieval of said new reference data, for responding to an entity that made said request that there is new reference data related to said conclusion; and wherein said fourth program instructions are recorded on said medium.

10. A computer program product as set forth in claim 6 wherein said first program instructions retrieve the first said reference data and said new reference data from a remote data source and store said first reference data and said new reference data in a local data repository, said remote data source being updated with said new reference data by an entity at a site different than where said local data repository resides.
